(19) United States
(12) Patent Application Publication
(10) Pub. No.: US 2024/0375157 A1
(43) Pub. Date: Nov. 14, 2024

(54) ADHESIVE ROLL MOUNTING SYSTEM FOR CONTACT CLEANING APPARATUS

(71) Applicant: Illinois Tool Works Inc., Glenview, IL (US)

(72) Inventor: Matthew BENNING, Glasgow (GB)

(21) Appl. No.: 18/661,179

(22) Filed: May 10, 2024

(30) Foreign Application Priority Data
May 11, 2023 (GB) 2306953.7
Apr. 10, 2024 (EP) 24169543.6

(51) Int. Cl. B08B 7/00; B08B 1/20; B08B 1/34; B08B 1/54

(52) U.S. Cl. CPC B08B 7/0028; B08B 1/20; B08B 1/34; B08B 1/54

(57) ABSTRACT

Example core plug assemblies for an adhesive roll mounting apparatus of a contact cleaning apparatus are disclosed, the assembly comprising a frustoconical moveable core plug and a frustoconical fixed core plug being spaced apart from one another along a common longitudinal axis and each configured and arranged to receive an end of a hollow adhesive roll core, the frustoconical moveable core plug being configured for translational movement towards and away from the frustoconical fixed core plug to increase the spacing between the core plugs.

### RELATED APPLICATIONS

The present application claims the benefit of United Kingdom (GB) Patent Application No. 2306953.7, filed May 11, 2023, and of European (EP) Patent Application No. 24169543.6, filed Apr. 10, 2024. The entireties of United Kingdom (GB) Patent Application No. 2306953.7 and European (EP) Patent Application No. 24169543.6 are expressly incorporated herein by reference.

### FIELD OF THE DISCLOSURE

The present disclosure relates to a core plug assembly for an adhesive roll mounting apparatus and an adhesive roll mounting apparatus for a contact cleaning system and particularly, but not exclusively, to an adhesive roll mounting system for a confined space contact cleaning system. Aspects of the disclosure relate to a moveable core plug assembly for an adhesive roll mounting apparatus, an adhesive roll mounting apparatus and to a contact cleaning system.

### BACKGROUND

A contact cleaning apparatus typically comprises a housing for each of a contact cleaning roller and an adhesive roll. Each of the roller and the roll is moved into and out of its respective housing via a drawer comprising a drawer slide mounted one at each side of the housing. The drawer slides, typically formed of an outer and inner member, are mounted one on each side of the housing, the outer members being attached to and extendible out of the housing and the inner members being attached to and extendible out of the outer members in a direction parallel with their longitudinal axes. The inner members are attached to a drawer end plate at an end opposite the outer member attachment. The drawer end plate serves to close an opening in the housing from which the drawer extends.

For the adhesive roll, a roll mounting system is carried on the members of the drawer slides and is moveable into and out of the housing as the members are retracted and extended into and out of the housing. The members and the mounting system together form a slidable drawer for moving an adhesive roll into and out of its housing.

The adhesive roll mounting system typically includes a pair of opposing core plugs mounted on the drawer slides. Each core plug is arranged and configured to fit within a hollow end of an adhesive roll core.

Typically, there is one fixed core plug attached to a mounting block which in turn is fixedly attached to the outer member of the drawer slide. The fixed core plug is moved into and out of the housing when the outer member of the drawer slide moves. The fixed core plug is fixed relative to the outer member of the drawer slide such that it moves translationally only when the outer member of the drawer slide is pulled out of the housing. Of the two opposing core plugs, the fixed core plug is usually located nearest to the housing when the drawer is fully opened and the drawer slides fully extended.

The adhesive roll mounting system also includes a moveable core plug attached to a mounting block which is then attached to the inner members of the drawer slides. The moveable core plug initially moves (translational movement) as the inner member of the drawer slides move out of the outer members and away from the housing. Once the drawer slides are fully extended, the opposing pair of core plugs are in a resting position and are ready to receive an adhesive roll.

The adhesive roll is typically a sheeted roll of adhesive material wrapped around a hollow roll core.

The distance between the opposing core plugs in this resting position is not quite long enough for the adhesive roll to fit and be retained in position, therefore, further movement of the moveable core plug is required.

The moveable core plug needs to provide space for an adhesive roll to be introduced into the drawer, and be removed from the same drawer. The drawer slides are of a given length for any machine and space for manoeuvring the adhesive roll into position is often limited. FIG. 1 shows a moveable core plug according to the prior art, wherein the moveable core plug is able to retract linearly along a core plug support against the bias of a spring and also rotate through multiple angles using a gimbal arrangement. The known arrangement is complex and expensive to manufacture. In addition, the known system has a number of moving parts which each provide a risk of failure.

It is an object of disclosure to at least mitigate one or more of the problems of the prior art.

### SUMMARY

Aspects and examples of the disclosure provide a core plug assembly for an adhesive roll mounting apparatus, an adhesive roll mounting apparatus and to a contact cleaning system as claimed in the appended claims.

According to an aspect of the disclosure, there is provided a core plug assembly for an adhesive roll mounting apparatus for a contact cleaning apparatus, the assembly comprising a frustoconical moveable core plug and a frustoconical fixed core plug being spaced apart from one another along a common longitudinal axis and each configured and arranged to receive an end of a hollow adhesive roll core, the frustoconical moveable core plug being configured for translational movement towards and away from the frustoconical fixed core plug to increase the spacing between the core plugs.

In some examples, the position of each core plug is at a substantially fixed angle to the common longitudinal axis.

In some examples, the frustoconical moveable core plug is translatable along the common longitudinal axis and rotatable about the common longitudinal axis. More specifically, movement of the frustoconical moveable core plug is limited only to translation and rotation about the common longitudinal axis. In other words, such translational and rotational movement of the frustoconical moveable plug relative to the common longitudinal axis in the only movement of the frustoconical moveable core plug.

In some examples, the frustoconical fixed core plug is rotatable about the common longitudinal axis. More specifically, movement of the frustoconical fixed core plug is limited only to rotation about the common longitudinal axis. In other words, such rotational movement of the frustoconical fixed plug relative to the common longitudinal axis in the only movement of the frustoconical fixed core plug.

In some examples, the frustoconical moveable core plug is limited to translational movement and rotational movement about a single axis. More specifically, the single axis is the common longitudinal axis of the frustoconical moveable core plug and the frustoconical fixed core plug.

In some examples, the core plug assembly comprises a frame. More specifically, the frustoconical moveable core plug and a frustoconical fixed core plug are mounted on the frame. In some examples, in a first position, the frustoconical moveable core plug and a frustoconical fixed core plug are spaced apart from one another by a first distance (A) wherein the distance A is sufficient to receive an adhesive roll between the core plugs. In a second position, the frustoconical moveable core plug and a frustoconical fixed core plug are spaced apart from one another by a second distance (B), greater than distance A and greater than the length of the adhesive roll to be received between them. The core plug assembly is moved between the first distance A and second distance B by the translational movement of the frustoconical moveable core plug relative to the frustoconical fixed core plug within the frame.

In some examples, the frame is a drawer. More specifically, the drawer comprises a pair of drawer slides. More specifically, the frustoconical moveable core plug and a frustoconical fixed core plug are mounted on the drawer. Yet more specifically, the frustoconical moveable core plug is mounted at an end of the drawer and the frustoconical fixed core plug is mounted at an opposing end of the drawer furthest from the end upon which the moveable core plug is mounted. In such embodiments, the translational movement of the moveable core plug towards and away from the frustoconical fixed core plug is independent of any movement of the inner and outer members of the drawer slides.

In some examples, each of the frustoconical moveable core plug and the frustoconical fixed core plug is attached to a respective mounting block.

In some examples, the frustoconical moveable core plug is biased away from its mounting block. More specifically, the frustoconical moveable core plug is biased away from its mounting block by a spring. Thus, the translational movement of the moveable core plug is against the bias of the spring which, in use, will return the moveable core plug towards the fixed core plug to hold an adhesive roll in place between the two opposing core plugs of the assembly.

In some examples the frustoconical moveable core plug is attached to its mounting block by a core plug support and is configured for translational movement towards and away from its mounting block along the core plug support. More specifically, the frustoconical moveable core plug is attached to its mounting block by a core plug support and is limited to translational movement towards and away from its mounting block along the core plug support and rotational movement about the common longitudinal axis.

In some examples, the core plug support is configured to pass through an aperture in the frustoconical moveable core plug as the frustoconical moveable core plug moves towards its mounting block. In such embodiments, there is preferably a retaining means (for example, a fastener such as a nut) to retain the moveable core plug on the core plug support.

In some examples, the core plug assembly comprises a latch mounted on the drawer, and an actuator operable to move the latch between a latching position and a disengaged position. Optionally, the actuator is a conical block or the actuator is a flanged block.

In some examples, the actuator is connected to the moveable core plug.

In some examples, the frustoconical moveable core plug extends from a broad proximal portion to a narrow distal portion. The actuator may be mounted to the proximal portion of the moveable core plug. Thus, in some examples, movement of the latch is actuated by the movement of the moveable core plug away from the fixed core plug.

In some examples, each of the frustoconical moveable core plug and the frustoconical fixed core plug has a conic angle of approximately 5 to 60 degrees, or 20 to 60 degrees, or 40 to 50 degrees. In other words, an angle between a sidewall of the frustoconical moveable core plug or the frustoconical fixed core plug and the common longitudinal axis is within one of these ranges. In one embodiment, each of the frustoconical moveable core plug and the frustoconical fixed core plug has a conic angle of approximately 45 degrees.

The combination of the shape of the core plugs of the core plug assembly and the translational movement of the moveable core plug relative to the fixed core plug provides a mechanically simpler and cheaper core plug assembly. Furthermore, the frustoconical shape of the core plugs minimises the assembly footprint.

In some examples, the moveable core plug includes a gripping element configured to engage the end of the hollow adhesive roll core, for example to fit into the end of the hollow adhesive roll core. Optionally, the gripping element may include a cylindrical surface, and/or may include a deformable surface, for example using an O-ring. Advantageously, the gripping element provides improved engagement between the adhesive roll and the moveable core plug while still providing clearance for the insertion or removal of the adhesive roll. The engagement may thereby be improved by providing a larger engagement surface area or increased friction between the core plug and roll core provides a more reliable interference fit.

In some examples, the frustoconical moveable core plug extends from a broad proximal portion to a narrow distal portion. The gripping element is adjacent to, for example adjoining, the proximal portion of the frustoconical moveable core plug.

In another embodiment the fixed core plug includes a gripping element configured to engage the end of the hollow adhesive roll core, for example to fit into the end of the hollow adhesive roll core. Optionally, the gripping element may include a cylindrical surface and/or may include a deformable surface, for example using an O-ring. Advantageously, the gripping element provides improved engagement between the adhesive roll and the fixed core plug while still providing clearance for the insertion or removal of the adhesive roll. The larger engagement surface area and/or increased friction between the core plug and roll core provides a more reliable interference fit.

In some examples, the frustoconical fixed core plug extends from a broad proximal portion to a narrow distal portion. The gripping element is adjacent to, for example adjoining, the proximal portion of the frustoconical fixed core plug.

In an alternative aspect of the disclosure there is provided a core plug assembly for an adhesive roll mounting apparatus for a contact cleaning apparatus, the assembly comprising a cylindrical moveable core plug and a cylindrical fixed core plug being spaced apart from one another along a common longitudinal axis and each configured and arranged to receive an end of a hollow adhesive roll core, the moveable core plug being mounted to a carriage operable to move the moveable core plug towards and away from the fixed core plug to increase the spacing between the core plugs, the moveable core plug being configured for, and translational movement relative to the fixed core plug.

In some examples, the position of each core plug is at a substantially fixed angle to the common longitudinal axis.

In some examples, the moveable core plug is translatable along the common longitudinal axis and rotatable about the common longitudinal axis. More specifically, movement of the moveable core plug is limited only to translation and rotation about the common longitudinal axis. In other words, such translational and rotational movement of the moveable plug relative to the common longitudinal axis in the only movement of the moveable core plug.

In some examples, the fixed core plug is rotatable about the common longitudinal axis. More specifically, movement of the fixed core plug is limited only to rotation about the common longitudinal axis. In other words, such rotational movement of the fixed plug relative to the common longitudinal axis in the only movement of the fixed core plug.

In some examples, the moveable core plug is limited to translational movement and rotational movement about a single axis. More specifically, the single axis is the common longitudinal axis of the moveable core plug and the fixed core plug.

In some examples, the core plug assembly comprises a frame. More specifically, the moveable core plug and a fixed core plug are mounted on the frame. In some examples, in a first position, the moveable core plug and a fixed core plug are spaced apart from one another by a first distance (A) wherein the distance A is sufficient to receive an adhesive roll between the core plugs. In a second position, the moveable core plug and a fixed core plug are spaced apart from one another by a second distance (B), greater than distance A and greater than the length of the adhesive roll to be received between them. The core plug assembly is moved between the first distance A and second distance B by the translational movement of the moveable core plug relative to the fixed core plug within the frame.

In some examples, the frame is a drawer. More specifically, the drawer comprises a pair of drawer slides. More specifically, the moveable core plug and a fixed core plug are mounted on the drawer. Yet more specifically, the carriage with the moveable core plug is moveably mounted at a first end of the drawer and the fixed core plug is mounted at an opposing end of the drawer furthest from the end upon which the moveable core plug is mounted. In such embodiments, the translational movement of the carriage holding the moveable core plug towards and away from the fixed core plug is independent of any movement of the inner and outer members of the drawer slides.

In some examples, each of the moveable core plug and the fixed core plug is attached to a respective mounting block.

In some examples, the moveable core plug is attached to the carriage by the mounting block.

In some examples, the assembly comprises a collapsible frame between the mounting block of the moveable core plug and a frame end plate. In this way, the carriage holding the mounting block of the moveable core plug is configured and arranged for translational movement towards and away from the frame end plate by collapsing and extending the collapsible frame between a first, stowed position, and a second, extended position.

In some examples, the collapsible frame is attached to the mounting block and the frame end plate such that moving the collapsible frame from the second position to the first position, causes the carriage, and the core plug mounted to it, to translate towards the frame end plate. In this way, space is created to insert an adhesive roll core onto into the core plug assembly.

In some examples, with an adhesive roll in place, moving the collapsible frame between a first, stowed position, and a second, extended position, translates the moveable core plug towards the adhesive roll core and into engagement with it.

According to a further aspect of the disclosure, there is provided an adhesive roll mounting apparatus comprising a housing and a drawer receivable in the housing and being moveable into and out of the housing, the drawer comprising a core plug assembly according to aspects of the present disclosure.

In some examples, the core plug assembly comprises a frustoconical moveable core plug and a frustoconical fixed core plug being spaced apart from one another along a common longitudinal axis and each configured and arranged to receive an end of a hollow adhesive roll core, the frustoconical moveable core plug being configured for translational movement towards and away from the frustoconical fixed core plug to increase the spacing between the core plugs.

In some examples, the position of each core plug is at a substantially fixed angle to the common longitudinal axis.

In some examples, the frustoconical moveable core plug is translatable along the common longitudinal axis and rotatable about the common longitudinal axis. More specifically, movement of the frustoconical moveable core plug is limited only to translation and rotation about the common longitudinal axis. In other words, such translational and rotational movement of the frustoconical moveable plug relative to the common longitudinal axis in the only movement of the frustoconical moveable core plug.

In some examples, the frustoconical fixed core plug is rotatable about the common longitudinal axis. More specifically, movement of the frustoconical fixed core plug is limited only to rotation about the common longitudinal axis. In other words, such rotational movement of the frustoconical fixed plug relative to the common longitudinal axis in the only movement of the frustoconical fixed core plug.

In some examples, the frustoconical moveable core plug is limited to translational movement and rotational movement about a single axis. More specifically, the single axis is the common longitudinal axis of the frustoconical moveable core plug and the frustoconical fixed core plug.

In some examples, the core plug assembly comprises a frame. More specifically, the frustoconical moveable core plug and a frustoconical fixed core plug are mounted on the frame. In some examples, in a first position, the frustoconical moveable core plug and a frustoconical fixed core plug are spaced apart from one another by a first distance (A) wherein the distance A is sufficient to receive an adhesive roll between the core plugs. In a second position, the frustoconical moveable core plug and a frustoconical fixed core plug are spaced apart from one another by a second distance (B), greater than distance A and greater than the length of the adhesive roll to be received between them. The core plug assembly is moved between the first distance A and second distance B by the translational movement of the frustoconical moveable core plug relative to the frustoconical fixed core plug within the frame.

In some examples, the frame is a drawer. More specifically, the drawer comprises a pair of drawer slides. In some examples, each drawer slide comprises at least two members, an outer member attachable to the housing and an inner member extendable out of the outer member in a direction parallel with their longitudinal axes to fully extend the drawer slides.

In some examples, each drawer slide comprises three members, an fixed member attachable to a housing, an outer member extendable along the fixed member, and an inner member extendable out of the outer member. More specifically, the outer member and the inner member are extendable in a telescopic manner in a direction parallel with the longitudinal axis of the fixed member.

In some examples, the frustoconical moveable core plug and a frustoconical fixed core plug are mounted on the drawer. Yet more specifically, the frustoconical moveable core plug is mounted at a first end of the drawer and the frustoconical fixed core plug is mounted at an opposing end of the drawer furthest from the end upon which the moveable core plug is mounted. In such embodiments, the translational movement of the moveable core plug towards and away from the frustoconical fixed core plug is independent of any movement of the inner and outer members of the drawer slides.

In some examples, the drawer slides are each mountable to the housing so as to allow the drawer to slide into and out of the housing.

In some examples, each of the frustoconical moveable core plug and the frustoconical fixed core plug is attached to a respective mounting block.

In some examples, the frustoconical moveable core plug is biased away from its mounting block. More specifically, the frustoconical moveable core plug is biased away from its mounting block by a spring. Thus, the translational movement of the moveable core plug is against the bias of the spring which, in use, will return the moveable core plug towards the fixed core plug to hold an adhesive roll in place between the two opposing core plugs of the assembly.

In some examples the frustoconical moveable core plug is attached to its mounting block by a core plug support and is configured for translational movement towards and away from its mounting block along the core plug support. More specifically, the frustoconical moveable core plug is attached to its mounting block by a core plug support and is limited to translational movement towards and away from its mounting block along the core plug support and rotational movement about the common longitudinal axis.

In some examples, the core plug support is configured to pass through an aperture in the frustoconical moveable core plug as the frustoconical moveable core plug moves towards its mounting block. In such embodiments, there is preferably a retaining means (for example, a fastener such as a nut) to retain the moveable core plug on the core plug support.

The combination of the shape of the core plugs of the core plug assembly and the translational movement of the moveable core plug relative to the fixed core plug provides a mechanically simpler and cheaper core plug assembly.

In some examples, one of the frustoconical core plugs is fixed in position in the frame.

In some examples, the other of the opposing frustoconical core plugs is moveable away from the fixed core plug in the frame. In this way, the moveable core plug may be moved away from the fixed core plug in order to receive an adhesive roll.

In some examples, the frustoconical moveable core plug has three positions relative to the frustoconical fixed core plug: a resting position, a biased position and an operating position. The resting position is the closest to the frustoconical fixed core plug, the biased position is furthest away from the frustoconical fixed core plug and the operating position is intermediate the resting and biased positions. In the resting position, there is no adhesive roll between the moveable and the fixed core plugs. In the biased position, the distance between the moveable and the fixed core plugs is greater than the length of the adhesive roll to be received and in the operating position, the moveable and the fixed core plugs are each located in their respective hollow ends of the adhesive roll core and are spaced at a distance which allows rotation of the adhesive roll about its longitudinal axis without any translation of the axis of rotation.

In some examples, the moveable core plug is mounted to an end of the drawer such that as the drawer is fully extended and the inner members of the drawer slide out of the outer members and away from the fixed members, the moveable core plug moves with the drawer.

In some examples, the apparatus comprises an adhesive roll retained between the opposing core plugs. In such embodiments, the action of the adhesive roll on the frustoconical moveable core plug holds the frustoconical moveable core plug in its operating position. When the adhesive roll is removed from the apparatus, the moveable core plug moves to its resting position.

According to yet another aspect of the disclosure, there is provided a contact cleaning apparatus comprising an adhesive roll mounting apparatus according to aspects of the present disclosure and a contact cleaning roller mounting apparatus comprising a housing and a drawer receivable in the housing and being moveable into and out of the housing, the drawer comprising a roll mounting system configured to receive and retain a contact cleaning roller wherein the adhesive roll mounting apparatus and the contact cleaning roller mounting apparatus together provide a contact cleaning roller configured and located to contact a substrate to be cleaned and an adhesive roll configured and located to remove debris from the contact cleaning roller.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more aspects of the disclosure will now be described by way of example only, with reference to the accompanying drawings, in which:

FIG. 1 shows a perspective view of a moveable core plug according to the prior art;

FIG. 2 shows a side view of an adhesive roll mounting apparatus including a core plug assembly according to a first aspect of the disclosure with the moveable core plug in its resting position;

FIG. 3 shows a side view of the adhesive roll mounting apparatus including the core plug assembly according to the disclosure with an adhesive roll received in the core plug assembly and the moveable core plug in an operating position;

FIG. 4 shows an enlarged view of the moveable core plug of the apparatus of FIG. 2;

FIG. 5 shows an enlarged view of the moveable core plug in circle A of the apparatus of FIG. 2 in its resting position;

FIG. 6 shows an enlarged view of the moveable core plug in circle B of the apparatus of FIG. 3 in its biased position;

FIG. 7 shows an enlarged view of the moveable core plug according to the disclosure during assembly of an adhesive roll in the adhesive roll mounting apparatus (a) in a resting position, (b) in a biased position and (c) in an operating position; and

FIG. 8 shows a perspective view of a contacting cleaning apparatus with a drawer including the adhesive roll mounting apparatus of FIG. 2 in an open position;

FIG. 9 shows a side view of an adhesive roll mounting apparatus including a moveable core plug according to a second aspect of the disclosure with the moveable core plug in a retracted position;

FIG. 10 shows a side view of the adhesive roll mounting apparatus including the moveable core plug of FIG. 9 with an adhesive roll received in the core plug assembly and the moveable core plug in an extended position; and

FIG. 11 shows a side view of another example of a moveable core plug according to the disclosure in an operating position.

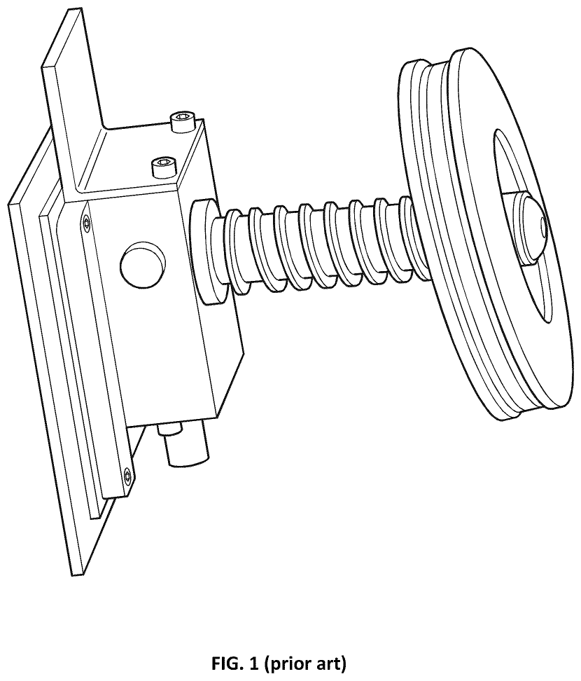

### DETAILED DESCRIPTION

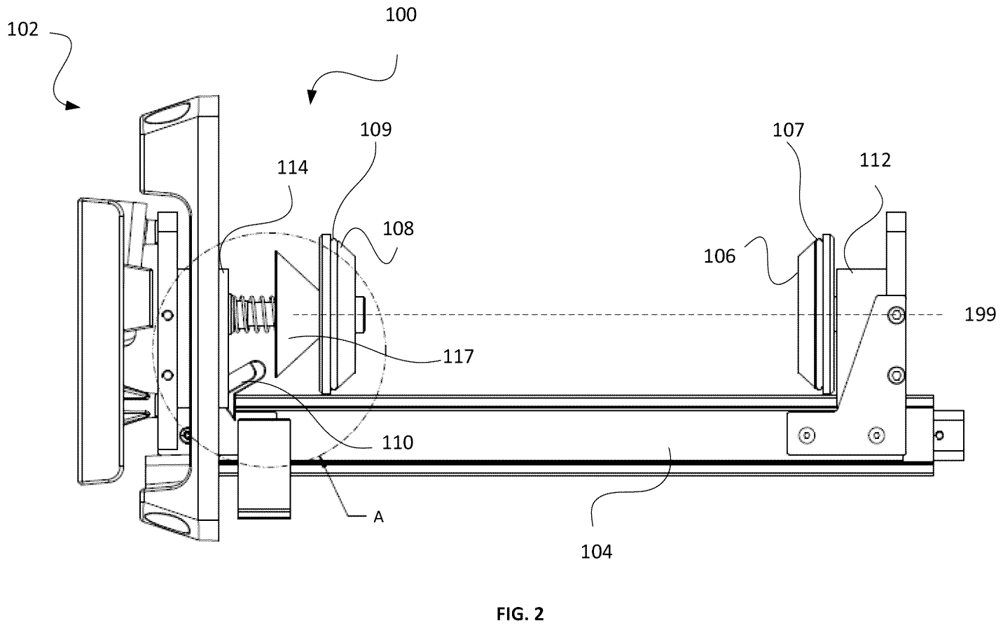

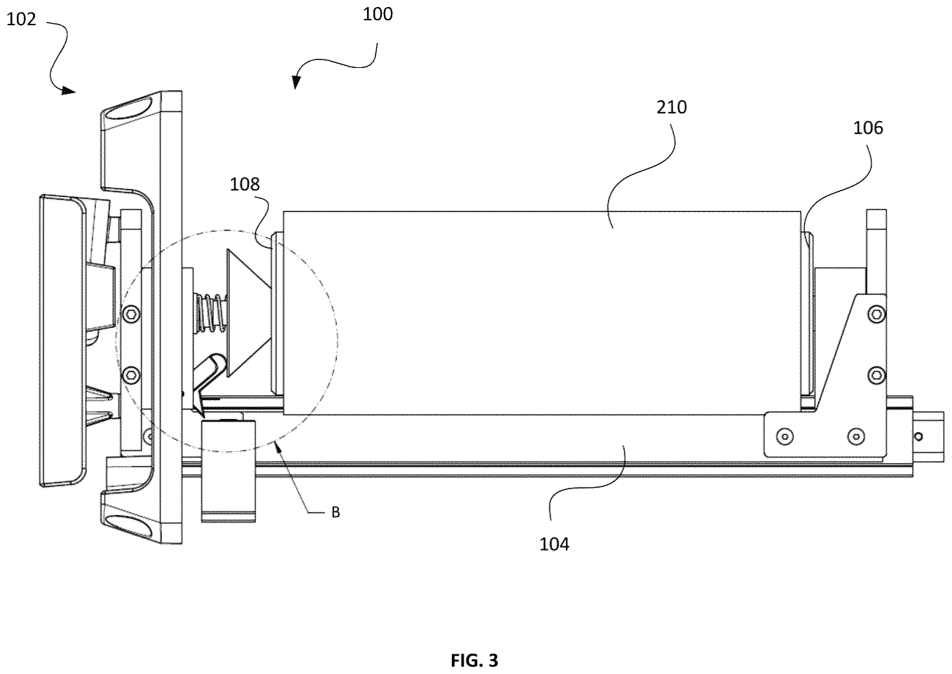

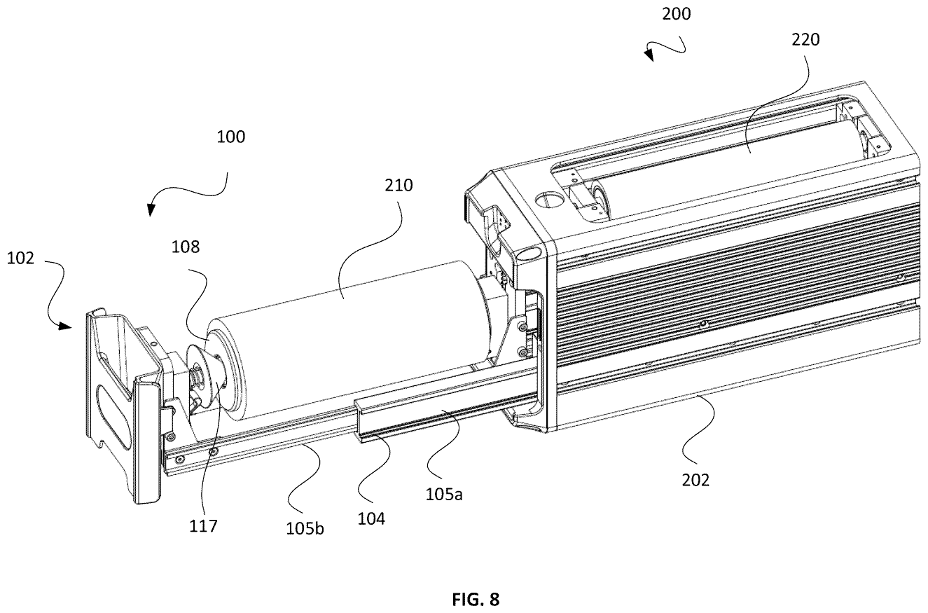

FIGS. 2 and 3 show an adhesive roll mounting apparatus 100 according to a first aspect of the disclosure in a drawer 102. The drawer 102 can be mounted in a housing (202, see FIG. 8) of a contact cleaning system (200, see FIG. 8). The drawer 102 includes a pair of opposing drawer slides 104, along which the drawer 102 can be retracted into the housing 202 to a closed position and extended out of the housing 202 to an open position.

As shown in FIG. 2, the roll mounting apparatus 100 includes a fixed core plug 106 and a moveable core plug 108 spaced apart from one another along a common longitudinal axis 199. The fixed core plug 106 and the moveable core plug 108 are mounted to the drawer 102 by mounting blocks 112 and 114, respectively. The fixed core plug 106 is mounted at a first end of the drawer 102 closest to the housing 202 when the drawer 102 is mounted to the housing 202 and in an open position. The fixed core plug 106 remains in a fixed position relative to the drawer 102. The moveable core plug 108 is mounted at a second end of the drawer 102, opposite the first end. The moveable core plug 108 is moveable in a linear direction away from the fixed core plug 106 in the drawer 102. The moveable core plug 108 can thus be moved away from the fixed core plug 106 in order to receive an adhesive roll (210, see FIG. 3).

The moveable core plug 108 is moveable in a translational manner towards and away from the fixed core plug 106. In other words, the moveable core plug 108 can move in a linear direction along the common longitudinal axis 199. Both the moveable core plug 108 and the fixed core plug 106 are rotatable about the common longitudinal axis 199. This rotational movement of the fixed and moveable core plugs allows the adhesive roll received therebetween to rotate when in use. The moveable core plug 108 and the fixed core plug 106 have a fixed angle relative to the drawer 102 and are not pivotable or moveable in any other direction. The fixed angle of the fixed and moveable core plugs 106, 108 may be subject to machine tolerances during manufacture of the fixed and moveable core plug 106, 108, thus the fixed angle is a substantially fixed angle. In other words, movement of the moveable core plug 108 is limited only to translation and rotation about the common longitudinal axis 199, and movement of the fixed core plug 106 is limited only to rotation about the common longitudinal axis 199.

The fixed core plug 106 and moveable core plug 108 each have a frustoconical shape. A narrow end of the fixed core plug 106 and moveable core plug 108 faces the opposing fixed core plug 106 or moveable core plug 108. This allows an end of each of the fixed core plug 106 and moveable core plug 108 to be received in a hollow adhesive roll core. An adhesive roll (not shown) can thus be mounted between the fixed core plug 106 and moveable core plug 108. FIG. 3 shows an adhesive roll 210 mounted between the fixed core plug 106 and the moveable core plug 108.

As shown in FIG. 2, a latch 110 is pivotally mounted at a second end of the drawer 102. The latch 110 is mounted on the drawer 102 by a pin, or by another means which provides a fulcrum about which the latch can pivot.

The movable core plug 108 includes an actuator 117 fixedly connected to, and movable with, the frustoconical portion of the moveable core plug 108. The actuator 117 is a conical block.

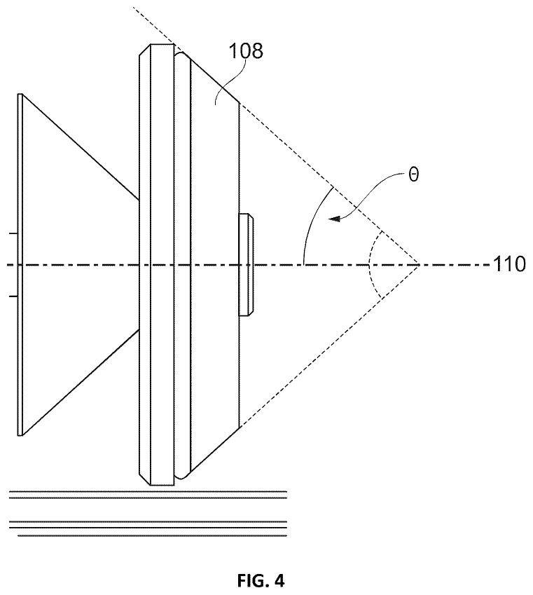

A surface of the actuator 117 is moveable into contact with the latch 110. The actuator can press against the latch 110 to actuate the latch 110 to pivot between a latching position and a disengaged position. As shown in FIG. 4, the moveable core plug 108 has a conic angle Q of approximately 5 to 60 degrees. Similarly, the fixed core plug 106 has a conic angle θ of approximately 5 to 60 degrees. That is, the angle between a sidewall of the moveable core plug 108 or the fixed core plug 106 and the common longitudinal axis 199 is approximately 5 to 60 degrees. The frustoconical shape of the moveable core plug 108 and the fixed core plug 106 minimises the assembly footprint. In one example, the conic angle θ of the fixed and moveable core plugs is 45 degrees. The conic angle may be dependent upon the distance between the fixed core plug 106 and the moveable core plug 108. For example, a higher conic angle will be selected for shorter distances between the fixed and moveable core plugs 106, 108 to allow for a greater angle of insertion of the adhesive roll 210, and a lower conic angle will be selected for longer distance between the fixed and moveable core plugs 106, 108.

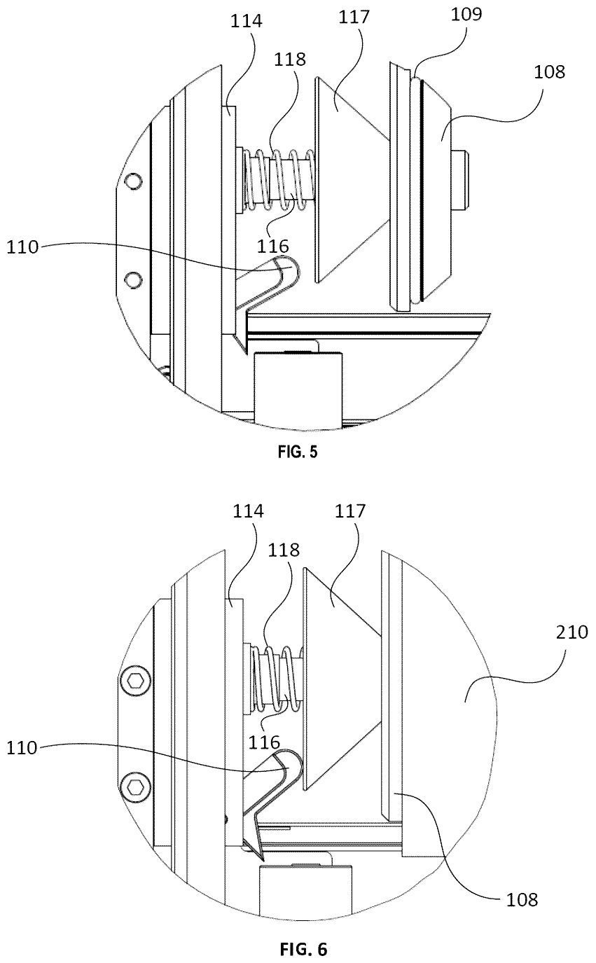

As shown in FIGS. 5 and 6, the moveable core plug 108 is mounted to its mounting block 114 by a core plug support 116 and a spring 118. The core plug support 116 is an elongate cylindrical member which passes through an aperture in the moveable core plug 108 as the moveable core plug 108 moves towards its mounting block 114. The sliding of the core plug support 116 through the aperture in the moveable core plug 108 permits translational movement of the moveable core plug towards and away from its mounting block 114. A retaining means is provided to retain the moveable core plug 108 on the core plug support 116. The retaining means may be a fastener, for example a nut.

The moveable core plug 108 is biased away from its mounting block 114 by the spring 118. Thus, the translational movement of the moveable core plug 108 is against the bias of the spring 118. In use, the spring 118 will return the moveable core plug 108 towards the fixed core plug (106, see FIGS. 2 and 3) to hold an adhesive roll 210 in place between the moveable core plug 108 and the fixed core plug 106.

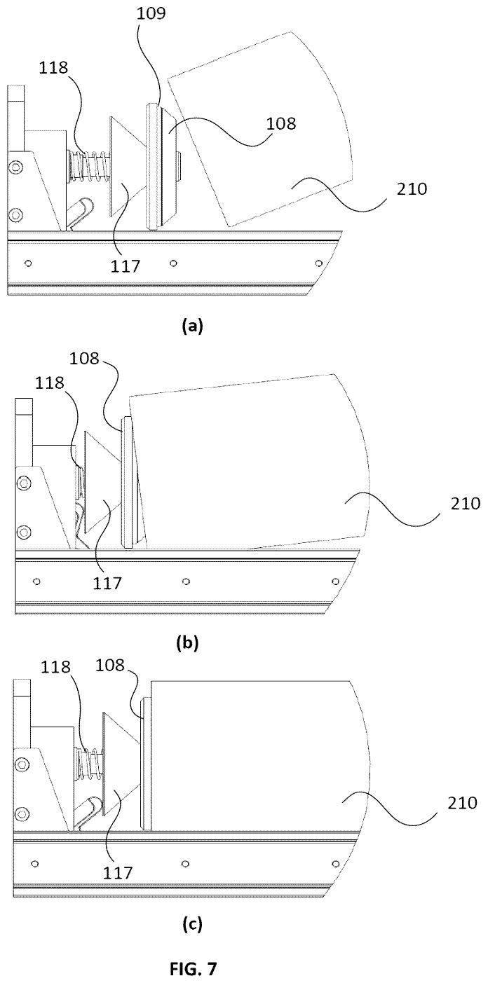

As shown in FIGS. 7(a) to (c), the moveable core plug 108 has three positions relative to the fixed core plug 106, a resting position (see FIG. 7(a)), a biased position (see FIG. 7(b)) and an operating position (see FIG. 7(c)). The moveable core plug 108 is biased towards the resting position by the spring 118.

In the resting position, as shown in FIGS. 2, 5 and 7(a), the moveable core plug 108 is the closest to the fixed core plug 106. There is no adhesive roll between the moveable core plug 108 and the fixed core plug 106. In the biased position, as shown in FIG. 7(b), the moveable core plug 108 is furthest away from the fixed core plug 106. The distance between the moveable core plug 108 and the fixed core plug 106 is greater than the length of an adhesive roll 210, allowing an adhesive roll 210 to be positioned between the fixed and moveable core plugs 106, 108 or removed from between the fixed and moveable core plugs 106, 108. In the operating position, as shown in FIGS. 3, 6 and 7(c), the moveable core plug 108 is intermediate the resting and biased positions. The moveable core plug 108 and the fixed core plug 106 are each located in their respective hollow ends of the adhesive roll core and are spaced at a distance which allows rotation of the adhesive roll 210 about its longitudinal axis without any translation of the axis of rotation.

The fixed and moveable core plugs 106, 108 include a gripping element 107, 108, for improved coupling to the adhesive roll. The gripping element 107, 109 includes a deformable surface. In the example shown in FIG. 2 and FIG. 5, the deformable surface is an O-ring.

FIG. 8 shows a contact cleaning apparatus 200 including a housing 202. The drawer 102, including the adhesive roll mounting apparatus 100, is slidable into and out of the housing 202 along the drawer slides 104. Each drawer slide 104 includes an outer member 105a, an inner member 105b and a fixed member (not shown). The outer member 105a, inner member 105b and fixed member are extendable in a telescopic manner. In one example, the fixed member is mounted to an internal surface of the housing 202. The outer member 105a is extendable along the fixed member, and the inner member 105b is extendable out of the outer member 105a in a direction parallel with the longitudinal axes of each of the outer and inner members 105a, 105b to fully extend the drawer slides 104. According to another example, the drawer slide 104 may only include two members, an outer member mounted to the housing 202 and an inner member extendable out of the outer member.

A contact cleaning roller 220 is mounted in the housing 202. An adhesive roll 210 is mounted in the adhesive roll mounting apparatus 100. The adhesive roll mounting apparatus 100 containing the adhesive roll 210 is slidable into, and fully receivable within, the housing 202 so that the adhesive roll 210 can be positioned in alignment with the contact cleaning roller 220. During use of the contact cleaning apparatus 200, the adhesive roll 210 is positioned such that the surface of the adhesive roll is in contact with the surface of the contact cleaning roller 220.

With reference to FIGS. 2 to 8, assembly of an adhesive roll 210 in the contact cleaning apparatus 200 will now be described. An end of the adhesive roll 210 is placed against the moveable core plug 108. The adhesive roll 210 can be used to move the moveable core plug 108 from the resting position (as shown in FIG. 7(a)) to the biased position (as shown in FIG. 7(b)). Alternatively, an operator may move the moveable core plug 108 by direct contact with the moveable core plug 108 or by using a lever (not shown), or movement of the moveable core plug 108 may be automated. This allows the adhesive roll 210 to be positioned between the moveable core plug 108 and the and the fixed core 106 plug such that an opposing end of the adhesive roll 210 can receive the fixed core plug 106 in the adhesive roll core. The moveable core plug 108 is then moved to the operating position (as shown in FIG. 7(c)) to hold the adhesive roll 210 in place. The adhesive roll 210 is then retained between the moveable core plug 108 and the fixed core plug 106 (as shown in FIG. 3) and the moveable core plug 108 remains in the operating position. The drawer 102 is then slid to a closed position such that it is fully received into the housing 202. With the drawer 102 in the closed position, the adhesive roll 210 contacts the contact cleaning roller 220 and the contact cleaning system 200 can be operated.

During use of the contact cleaning apparatus 200, a substrate is passed over the contact cleaning roller 220 which rotates along the surface of the substrate and removes debris from the substrate. The adhesive roll 210 is rotated by the rotation of the contact cleaning roller 220 and collects the debris from contact cleaning roller 220. During operation of the contact cleaning apparatus 200, an outer surface of the adhesive roll 210 can be replenished, either by adding an adhesive layer to the adhesive roll 210 or removing an adhesive layer from the adhesive roll 210.

When the adhesive roll 210 is no longer usable, an operator will open the drawer 102 and move the moveable core plug 108 to the biased position to remove the spent adhesive roll 210. The moveable core plug 108 is then released and returns to the resting position by spring bias. A fresh adhesive roll 210 can then be replaced between the moveable core plug 108 and the fixed core plug 106, as outlined above.

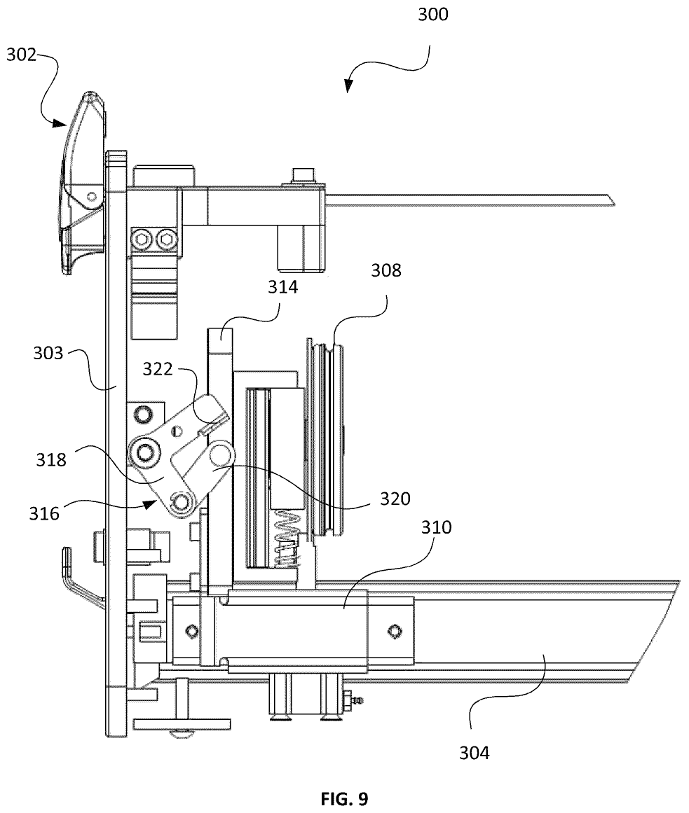

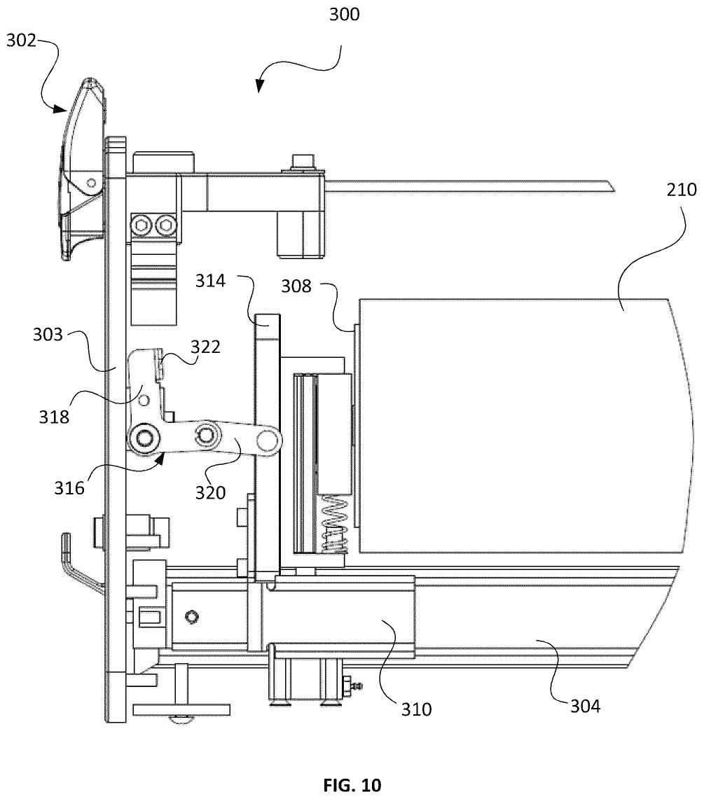

FIGS. 9 and 10 show an adhesive roll mounting apparatus 300 according to a second aspect of the disclosure in a drawer 302. Similarly to the embodiment shown in FIG. 8, the drawer 302 can be mounted in a housing of a contact cleaning system. The drawer 302 includes a pair of opposing drawer slides 304, along which the drawer can be retracted into the housing to a closed position and extended out of the housing to an open position.

The roll mounting apparatus 300 includes a fixed core plug (not shown) and a moveable core plug 308 spaced apart from one another along a common longitudinal axis. The fixed core plug is mounted to the drawer 302 by a mounting block (not shown), and the moveable core plug 308 is mounted to the drawer 302 by a mounting block 314. The fixed core plug is mounted at a first end of the drawer 302 closest to the housing when the drawer is mounted to the housing and in an open position. The fixed core plug remains in a fixed position relative to the drawer. The moveable core plug 308 is mounted at a second end of the drawer 302, opposite the first end. The moveable core plug 308 is moveable in a linear direction away from the fixed core plug in the drawer. The moveable core plug 308 can thus be moved away from the fixed core plug in order to receive an adhesive roll 210.

The moveable core plug 308 can only be moved in a translational manner towards and away from the fixed core plug. In other words, the moveable core plug 308 can only move in a linear direction along the common longitudinal axis. Both the moveable core plug 308 and the fixed core plug have a fixed angle relative to the drawer 302 and are not pivotable.

The fixed core plug and moveable core plug 308 may have any suitable shape, for example a conical shape, a frustoconical shape, or a cylindrical shape. The roll mounting apparatus shown in FIG. 9 has a cylindrical shaped moveable core plug 308.

The moveable core plug 308 is mounted to a carriage 310 via the mounting block 314. The carriage 310 is slidably mounted to the drawer 302 so as to convey the moveable core plug 308 linearly. More specifically, the carriage 310 may be slidably mounted on least one of the drawer slides 304 or on a rail (not shown) fixedly mounted to the drawer 302.

A collapsible frame 316 is provided between the mounting block 314 of the moveable core plug 308 and an end plate 303 of the drawer 302. The carriage 310 holding the mounting block 314 of the moveable core plug 308 is slidable to permit translational movement towards and away from the frame end plate 303 by collapsing and extending the collapsible frame 316 between a first, stowed position (as shown in FIG. 9), and a second, extended position (as shown in FIG. 10).

The collapsible frame 316 includes a first member 318 pivotally mounted to the end plate 303 of the drawer. The first member 318 is an L-shaped member having a first arm and a second arm. The first member 318 is pivotally mounted to the end plate 303 at a pivot point between the first arm and the second arm. The collapsible frame 316 also includes a second member 320 pivotally mounted at a first end to an end of the second arm of the first member 318 and at a second end to the mounting block 314 of the moveable core plug 308.

As shown in FIG. 9, in the first, stowed position of the collapsible frame 316, the second member 320 is at an angle with respect the second arm of the first member 318, i.e. folded, reducing the distance between the end plate 303 and the mounting block 314. As shown in FIG. 10, in the second, extended position, the second member 320 is collinear with the second arm of the first member 318, increasing the distance between the end plate 303 and the mounting block 314.

An end of the first arm of the first member 318 may include a stopper 322. The stopper 322 contacts the mounting block 314 of the moveable core plug 308 in the first position. The stopper 322 may be made from an elastomer or a rubber material so as to prevent damage to the moveable core plug 308 during assembly and disassembly of the adhesive roll 210.

To assemble an adhesive roll in the roll mounting apparatus 300, the collapsible frame 316 is first moved from the second position to the first position, causing the carriage 310, and the moveable core plug 308 mounted to it, to translate towards the frame end plate 303. This creates space to mount an adhesive roll 210 between the moveable core plug 308 and the fixed core plug. The adhesive roll 210 is placed between the moveable core plug 308 and the fixed core plug. The collapsible frame 316 is then moved from the first position back to the second position to translate the moveable core plug 308 towards the adhesive roll 210. The moveable core plug 308 and the fixed core plug are received in the adhesive roll core and hold the adhesive roll 210 in an assembled position.

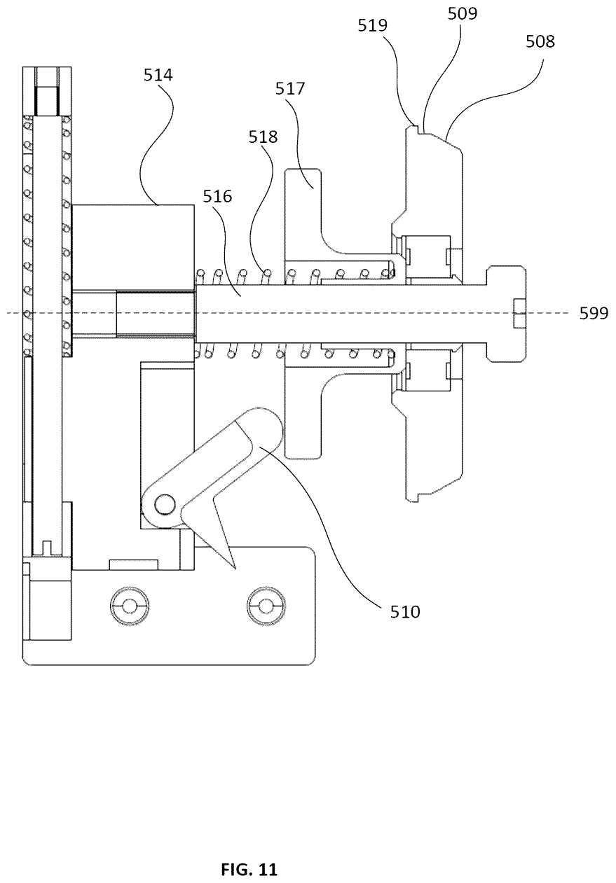

As shown in FIG. 11, there is shown another example of a moveable core plug 508 according to the disclosure in an operating position. Where the features are the same as the example of FIG. 2 to FIG. 8, the reference numbers are also kept the same, but with a “5” as the initial digit.

Similar to the embodiment shown in FIG. 2 to FIG. 8, a latch 510 is pivotally mounted at a second end of the drawer. The latch 510 is mounted on the drawer by a pin, or by another means which provides a fulcrum about which the latch can pivot.

The movable core plug 508 includes an actuator 517 fixedly connected to, and movable with, the frustoconical portion of the moveable core plug 508.

The actuator 517 is a flanged block. The actuator 517 allows a user to pull back the spring-loaded section by hand, moving the moveable core plug 508 towards the mounting block 514 to aid replacement of the adhesive roll 210.

The moveable core plug 508 includes a gripping element 509. The gripping element 509 is a cylindrical surface. The circumference of the cylindrical surface is configured to provide an interference fit with the adhesive roll core. Optionally, and the fixed core plug (not shown) also includes a corresponding gripping element.

The moveable core plug includes a stopping element 519. The stopping element 519 is configured to abut the adhesive roll core and limit axial movement of the adhesive roll when it is in the loaded position.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

### LIST OF PARTS

Adhesive roll mounting apparatus 100
Drawer/frame 102
Drawer slides 104
Outer member 105a
Inner member 105b
Fixed core plug 106
Moveable core plug 108
Common longitudinal axis 199
Mounting block 112, 114
Core plug support 116
Spring 118
Contact cleaning apparatus 200
Housing 202
Adhesive roll 210
Contact cleaning roller 220
Adhesive roll mounting apparatus 300
Drawer/frame 302
End plate 303
Drawer slides 304
Moveable core plug 308
Carriage 310
Mounting block 314
Collapsible frame 316
First member 318
Second member 320
Stopper 322
Moveable core plug 508
Gripping element 509
Latch 510
Mounting block 514
Core plug support 516
Actuator 517
Spring 518
Stopping element 519
Common longitudinal axis 599

What is claimed is:

1. A core plug assembly for an adhesive roll mounting apparatus for a contact cleaning apparatus, the assembly comprising a frustoconical moveable core plug and a frustoconical fixed core plug being spaced apart from one another along a common longitudinal axis and each configured and arranged to receive an end of a hollow adhesive roll core, the frustoconical moveable core plug being configured for translational movement towards and away from the frustoconical fixed core plug to increase the spacing between the core plugs.

2. The core plug assembly according to claim 1, wherein the position of each core plug is at a substantially fixed angle to the common longitudinal axis.

3. The core plug assembly according to claim 1, wherein the frustoconical moveable core plug is translatable along the common longitudinal axis and rotatable about the common longitudinal axis.

4. The core plug assembly according to claim 1, wherein the fixed core plug is rotatable about the common longitudinal axis.

5. The core plug assembly according to claim 1, wherein the core plug assembly comprises a frame.

6. The core plug assembly according to claim 5, wherein the frustoconical moveable core plug and a frustoconical fixed core plug are mounted on the frame.

7. The core plug assembly according to claim 5, wherein the frame comprises a pair of drawer slides and the frustoconical moveable core plug and a frustoconical fixed core plug are mounted on the drawer slides.

8. The core plug assembly according to claim 1, wherein each of the frustoconical moveable core plug and the frustoconical fixed core plug is attached to a respective mounting block.

9. The core plug assembly according to claim 8, wherein the frustoconical moveable core plug is biased away from its mounting block.

10. The core plug assembly according to claim 8, wherein the frustoconical moveable core plug is attached to its mounting block by a core plug support and is configured for translational movement towards and away from its mounting block along the core plug support.

11. The core plug assembly according to claim 1, wherein each of the frustoconical moveable core plug and the frustoconical fixed core plug has a conic angle of approximately 5 to 60 degrees.

12. The core plug assembly according to claim 1, wherein the frustoconical core plug comprises a gripping element.

13. An adhesive roll mounting apparatus comprising a housing and a drawer receivable in the housing and being moveable into and out of the housing, the drawer comprising a core plug assembly according to claim 1.

14. A contact cleaning apparatus comprising:
an adhesive roll mounting apparatus according to claim 13; and
a contact cleaning roller mounting apparatus comprising a housing and a drawer receivable in the housing and being moveable into and out of the housing, the drawer comprising a roll mounting system configured to receive and retain a contact cleaning roller wherein the adhesive roll mounting apparatus and the contact cleaning roller mounting apparatus together provide a contact cleaning roller configured and located to contact a substrate to be cleaned and an adhesive roll configured and located to remove debris from the contact cleaning roller.

15. The contact cleaning apparatus according to claim 14, wherein the frustoconical core plug comprises a gripping element.

16. The contact cleaning apparatus according to claim 15, wherein the frustoconical core plug extends from a broad proximal portion to a narrow distal portion, and wherein the gripping element is adjacent to the proximal portion of the frustoconical core plug.

17. The contact cleaning apparatus according to claim 15, wherein the frustoconical core plug extends from a broad proximal portion to a narrow distal portion, and wherein the gripping element is adjoining the proximal portion of the frustoconical core plug.
